(19) United States
(12) Patent Application Publication
(10) Pub. No.: US 2007/0294610 A1
(43) Pub. Date: Dec. 20, 2007

(54) System and method for identifying similar portions in documents

(76) Inventor: Phillip W. Ching, Gaithersburg, MD (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/445,795

(22) Filed: Jun. 2, 2006

(51) Int. Cl. G06F 17/00; G06F 17/30

(52) U.S. Cl. 715/500; 715/530; 707/1

(57) ABSTRACT

A document comparison system comprising a computer and software accessible to and executable by said computer. Said computer is operable to compare a first document and a second document; based on said comparison, identify one or more similar portions of said first and second documents; provide a display containing simultaneously at least some of the contents of said first and second documents; indicate in said displayed contents of said first and second documents at least one of said identified similar portions; receive a selection of one of said indicated similar portions; and in response to said selection, further indicate said selected similar portion in said displayed contents of said first and second documents.

### BACKGROUND

1. Field of the Invention

Certain embodiments disclosed herein relate generally to the field of document comparison. More particularly, there is disclosed a system and method for identifying similar portions of text within one or more documents.

2. Description of the Related Art

The advent of text processing application programs has enabled the computer to become a viable tool for document creation and storage. A user is able to develop a document by entering the text comprising the document into a computer using an application program. Typically, the document contents are stored on the computer in what is known as a file.

In a business or government setting, many electronically stored documents are created. Often, it is necessary within a document to repeat standard phrases or sentences throughout the document to satisfy customary wording conventions and the notion of consistency. Also, professional environments commonly generate related documents and documents that cross-reference one another. As a result, many of these documents share similar phrases or sentences. For example, a second document may include several quotations to a first document. Thus, a need naturally arises to be able to quickly and accurately verify if quotations to the first document are precisely reproduced in the second document.

In an academic setting, many electronic documents on a similar topic are typically generated by students in a given course. Due to the competitive environment of higher education, plagiarism is a problem that misrepresents a student's ability. Oftentimes, if a student rearranges sentences and paragraphs, it can be difficult for a professor evaluating multiple submitted documents to identify an impermissibly similar document pair.

Commercially available word processing programs such as Microsoft® Word® 2003, from Microsoft Corporation®, and WordPerfect® version 12.0, from WordPerfect Corporation®, permit the searching of documents using a key phrase. However, these programs cannot identify multiple sets of similar portions in the same document. Moreover, when comparing multiple documents, these programs require the user to manually select and search each document in turn. This is a time-consuming and laborious process.

### SUMMARY

Systems and methods disclosed herein identify similar portions of text in one or more documents stored on a computer. The systems and methods allow a user to efficiently identify and view similar portions that appear at least twice within the document or documents. By selecting an identified similar portion of text, the user can be directed to another instance of the identified similar portion of text. In some embodiments, the system is also capable of displaying a list of the identified similar portions of text on a display unit.

In one embodiment, a document comparison system comprises a computer and software accessible to and executable by said computer. Said computer is operable to compare a first document and a second document; based on said comparison, identify one or more similar portions of said first and second documents; provide a display containing simultaneously at least some of the contents of said first and second documents; indicate in said displayed contents of said first and second documents at least one of said identified similar portions; receive a selection of one of said indicated similar portions; and in response to said selection, further indicate said selected similar portion in said displayed contents of said first and second documents.

In another embodiment, a document comparison system comprises a computer and software accessible to and executable by said computer. Said computer is operable to compare a first document and a second document; based on said comparison, identify one or more similar portions of said documents; and provide a display containing simultaneously (i) at least some of the contents of said first document, (ii) at least some of the contents of said second document, and (iii) a list of said identified similar portions.

In yet another embodiment, a method for comparing document comprises comparing a first document and a second document; based on said comparison, identifying one or more similar portions of said first and second documents; displaying simultaneously at least some of the contents of said first and second documents; indicating in said displayed contents of said first and second documents at least one of said identified similar portions; receiving a selection of one of said indicated similar portions; and in response to said selection, further indicating said selected similar portion in said displayed contents of said first and second documents.

In a further embodiment, a method for comparing document comprises comparing a first document and a second document; based on said comparison, identifying one or more similar portions of said first and second documents; and displaying simultaneously (i) at least some of the contents of said first document, (ii) at least some of the contents of said second document, and (iii) a list of said identified similar portions.

In another embodiment, a document comparison system comprises a computer and software accessible to and executable by said computer. Said computer is operable to receive a document; identify a first portion of said document and a second portion of said document, said second portion being similar to said first portion; provide a display containing at least some of the contents of said document; indicate said first and second portions in said displayed contents; receive a selection of said first portion; and in response to said selection, further indicate said second portion.

In yet another embodiment, a method for comparing a document comprises receiving a document; identifying a first portion of said document and a second portion of said document, said first portion being similar to said second portion; providing a display containing at least some of the contents of said document; indicating said first and second portions in said displayed contents; receiving a selection of said first portion; and in response to said selection, further indicating said second portion.

For purposes of this summary, certain aspects, advantages, and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

### BRIEF DESCRIPTION OF THE DRAWINGS

FIG. 1A is a system block diagram illustrating several embodiments of the overall network architecture.

FIG. 1B is a high-level block diagram illustrating one embodiment of the document comparison module.

FIG. 2 is a high-level block diagram illustrating one embodiment of the document comparison method that compares two documents.

FIG. 3 is a flow-chart illustrating one embodiment of the document comparison method.

FIG. 4A is a representation of one embodiment of an HTML page displaying user authentication fields.

FIG. 4B is a representation of one embodiment of an HTML page displaying a user's document selection options.

FIG. 4C is a representation of one embodiment of an HTML page displaying two documents side-by-side and a list of identified similar text portions in the documents.

FIG. 4D is a representation of one embodiment of an HTML page displaying two documents side-by-side and a list of identified similar text portions in the documents after a user has selected one identified similar text portion.

### DETAILED DESCRIPTION OF THE PREFERRED EMBODIMENTS

Systems and methods which represent various embodiments and an example application of an embodiment of the invention will now be described with reference to the drawings. Variations to the systems and methods which represent still other embodiments will also be described.

For purposes of illustration, some embodiments will be described in the context of a standalone computer. It is contemplated that the invention(s) disclosed herein are not limited by the type of environment in which the systems and methods are used, and that the systems and methods may be used in other environments, such as, for example, the Internet, the World Wide Web, a private network for a hospital, a broadcast network for a government agency, an internal network of a corporate enterprise, an intranet, a wide area network, and so forth. Additionally, the specific implementations described herein are set forth in order to illustrate, and not to limit, the invention(s) disclosed herein. The scope of the invention(s) is defined only by the appended claims.

These and other features will now be described with reference to the drawings summarized above. The drawings and the associated descriptions are provided to illustrate embodiments of the invention and not to limit the scope of the invention. Throughout the drawings, reference numbers may be re-used to indicate correspondence between referenced elements.

### I. Overview

In one embodiment, a document server facilitates a side-by-side, external comparison of documents over a communication medium. A user first selects two documents. These documents may be stored locally on the user's computer or on the document server. After selection, the documents are compared by the user's computer and/or the document server in order to identify portions of text that are common to both documents. The result of the comparison is presented in a side-by-side display showing at least some of the contents of each document. The display identifies the similar portions of text using a color scheme and/or another visual indicator. When the user selects an identified similar portion of text in one of the displayed documents, the system further indicates the selected portion of text and also further indicates the corresponding similar portion of text in the other document. The system further indicates the selected portion of text by using a unique color and/or some other unique visual indicator.

For example, if a user selects document A and document B for comparison, the system will display documents A and B in the side-by side display. Portions of text common to both documents are identified as similar portions and can be indicated to the user using, for example, blue text. The other dissimilar portions of text in the documents can be displayed using a different color, for example, black text. Then, if the user selects an identified similar portion of text in document A, the system can change the color of the selected portion of text from blue to another different color, for example, red. Additionally, all other instances of the selected portion in document B can also be changed from blue to red text.

In another embodiment, the system can display a third window on the display unit along with the side-by-side display. When employed, the third window contains a list of the identified similar portions in the compared documents. The user can select one of the listed similar portions of text in order to further indicate the selected similar portions in the other windows of the side-by-side display. As an extension of the preceding example, if the user selects sentence A from the displayed list, sentence A in the list changes from blue to red text. Additionally, the system can change every instance (or one or some of the instances) of the selected similar portion (sentence A) in documents A and B in the display windows from blue to red text.

In another embodiment, the system performs an internal comparison of a single document. First, the single document is selected by the user. The document can be stored either locally or on a remote server. After selection, the system searches the selected document for portions of text that are repeated at least once within the document. The system displays the document on the display unit and indicates the identified similar portions using a contrasting color or other visual indicator. When the user selects one of the identified similar portions, the system can further indicate each instance (or one or some instances) of that similar portion in the displayed document. The system further indicates the selected similar portions by using a unique or contrasting color or some other visual indicator.

For example, a user selects document A from a list of documents for comparison. Based on the contents of the document, the system identifies sentence A and sentence B as similar portions of text that are repeated at least once in the document. The system then displays some or all instances of sentences A and B using blue text. After the user selects one instance of sentence A, some or all instances of sentence A are changed from blue to red text.

In some embodiments, the user may use a spectrum of colors to distinguish between each of the identified similar portions (for example, similar sentence A identified using green text and similar sentence B identified using yellow text). In these embodiments, the system does not need to further indicate selected identified portions because each identified portion is already displayed in a unique text color.

Alternatively, the system may perform the internal document comparison by displaying a second window on the display unit. The second window preferably lists each identified similar portion of text in the document. If the user selects an identified portion of text from the list, the system further indicates that selection in the displayed contents of the document using a unique or contrasting color or another visual indicator. As an extension of the preceding example, if the user selects sentence A from the list, the system will change all instances of sentence A in the displayed document from blue to red text.

In a further embodiment, the system compares selected documents and identifies portions of text common to the documents. The system then generates a similarity rating that is output to the display unit. The similarity rating provides the user with a representation of the degree of similarity between the selected documents.

In another embodiment, the system accepts a selection of more than two documents and identifies portions of text that are common to all of the selected documents. Upon selection of an identified portion of text, the system further indicates the selected portion in all of the documents. The documents are displayed on the display unit simultaneously, one at a time, or as the user specifies.

In yet another embodiment, the system accepts a selection of multiple documents. The system then compares each possible pair of documents and identifies similar portions of text common to each pair of documents. After the comparison is made, the system generates a similarity rating for each possible pair of documents. In some embodiments, the similarity ratings are displayed as each pair of documents is displayed. In other embodiments, the similarity ratings are displayed as an ordered list on the display unit.

### II. System Architecture

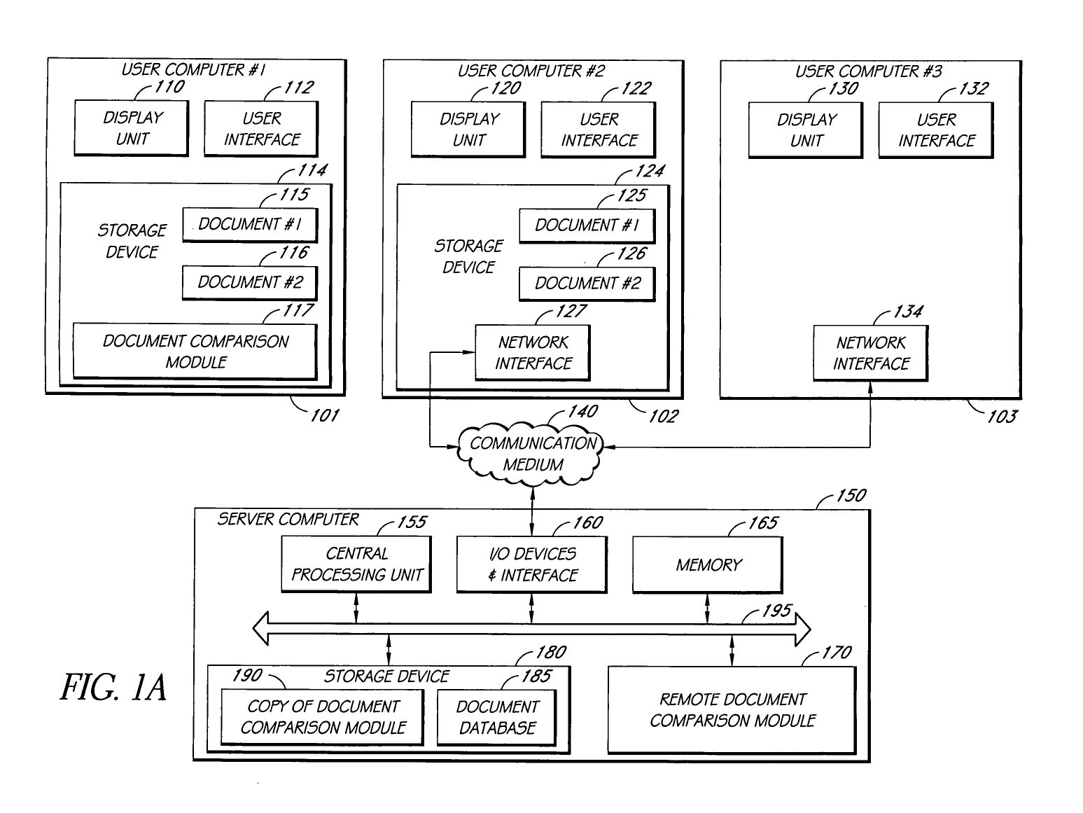

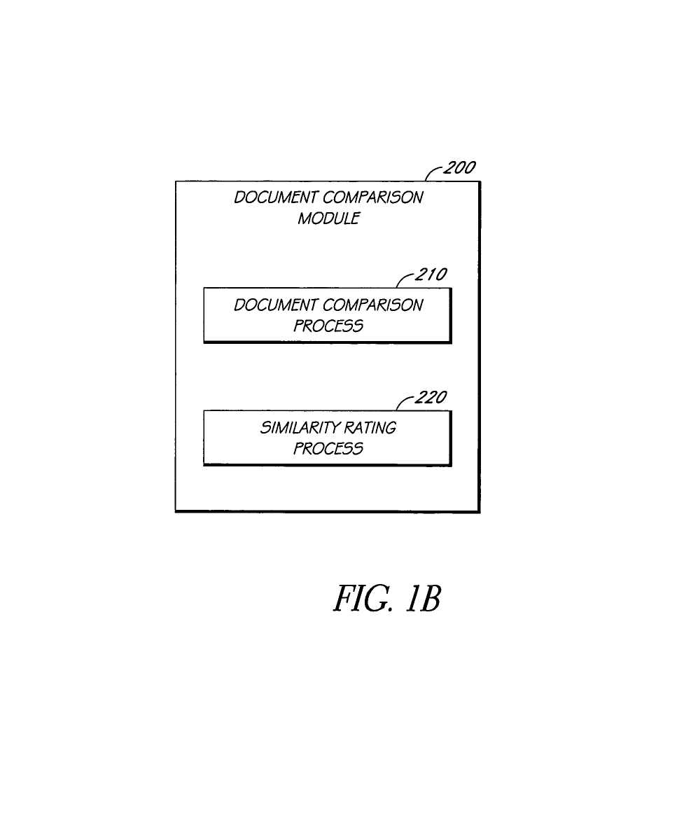

FIG. 1A illustrates a system block diagram illustrating several embodiments of an overall network architecture suitable for use in connection with the various systems and methods disclosed herein. In one embodiment, user computers 102, 103 communicate over a communication medium 140 with a server computer 150 to perform the document comparison. Alternatively, a computer 101 may comprise the entire system for performing the document comparison.

The server computer 150 may include some or all of the following: a central processing unit 155, an Input/Output Interface 160, memory 165, a storage device 180, a data bus 195, and a remote document comparison module 170. In some embodiments, the storage device 185 stores a copy of the document comparison module 190 remotely from the user computer(s) 102, 103. In these embodiments, a user may download a copy of the document comparison module 190 so that the processes of the document comparison module run locally on the user's computer 102. In other embodiments, the storage device 180 remotely stores a plurality of documents on a document database 185.

It is recognized that the term “remote” may include data, objects, devices, components, and/or modules not stored locally and not accessible via the bus 195. Thus, remote data may include a system which is physically stored in the same room and connected to the user's system via a network. In other situations, a remote system may also be located in a separate geographic area, such as, for example, in a different location, city or country.

The user computers 101, 102, 103 and the server computer 150 may be a microprocessor or processor (hereinafter referred to as processor) controlled device that permits access to the communication medium 140, including terminal devices, such as personal computers, workstations, servers, mini computers, main-frame computers, laptop computers, a network of individual computers, mobile computers, palm top computers, hand held computers, a set top box for a TV, an interactive television, an interactive kiosk, a personal digital assistant, an interactive wireless communications device, or a combination thereof. The computers can further possess input devices 112, 122, 132 such as a keyboard or a mouse, and/or output devices such as a computer screen 110, 120, 130 or a speaker. Furthermore, the computers may serve as clients, servers, or a combination thereof.

The computers 101, 102, 103, 150 may be uniprocessor or multiprocessor machines. Additionally, these computers 101, 102, 103, 150 can include an addressable storage medium 114, 124, 180 or computer accessible medium, such as random access memory (RAM), an electronically erasable programmable read-only memory (EEPROM), programmable read-only memory (PROM), erasable programmable read-only memory (EPROM), hard disks, floppy disks, laser disk players, digital video devices, compact disks, CD-ROMs, DVD-ROMs, video tapes, audio tapes, magnetic recording tracks, electronic networks, and other apparatus suitable to transmit or store electronic content such as, by way of example, programs and data. In one preferred embodiment, the computers 102, 103, 150 are equipped with a network communication device 127, 134, 160 such as a network interface card, a modem, or other network connection device suitable for connecting to the communication medium 140. Furthermore, the computers 101, 102, 103, 150 can preferably execute an appropriate operating system such as Unix, Linux, Microsoft® Windows® 95, Microsoft® Windows® 2000, Microsoft® Windows® NT, Microsoft® Windows® XP, Apple® MacOS®, or IBM® OS/2®. As is conventional, the appropriate operating system can include a communications protocol implementation which handles incoming and outgoing message traffic passed over the communication medium 140. In other embodiments, while the operating system may differ depending on the type of computer, the operating system can nonetheless provide the appropriate communications protocols necessary to establish communication links with the communication medium 140.

The communication medium 140 may advantageously facilitate the transfer of electronic content. In one embodiment, the communication medium 140 includes the Internet. The Internet is a global network connecting millions of computers. The structure of the Internet, which is well known to those of ordinary skill in the art, is a global network of computer networks utilizing a simple, standard common addressing system and communications protocol called Transmission Control Protocol/Internet Protocol (TCP/IP). The connections between different networks are called “gateways”, and the gateways serve to transfer electronic data worldwide.

In one embodiment, the Internet includes a Domain Name Service (DNS). As is well known in the art, the Internet is based on Internet Protocol (IP) addresses. The DNS translates alphabetic domain names into IP addresses, and vice versa. The DNS is comprised of multiple DNS servers situated on multiple networks. In translating a particular domain name into an IP address, multiple DNS servers may be accessed until the domain name translation is accomplished.

One part of the Internet is the World Wide Web (WWW). The WWW is generally used to refer to both (1) a distributed collection of interlinked, user-viewable hypertext documents (commonly referred to as “web documents” or “web pages” or “electronic pages” or “home pages” or “HTML pages”) that are accessible via the Internet, and (2) the client and server software components which provide user access to such documents using standardized Internet protocols. The web documents are encoded using Hypertext Markup Language (HTML) and the primary standard protocol for allowing applications to locate and acquire web documents is the Hypertext Transfer Protocol (HTTP). However, the term WWW is intended to encompass future markup languages and transport protocols which may be used in place of, or in addition to, HTML and HTTP.

The WWW contains different computers which store electronic pages, such as HTML documents, capable of displaying graphical and textual information. Information provided by the document server computer 150 on the WWW is generally referred to as a “website.” A website is defined by an Internet address, and the Internet address has an associated electronic page. Generally, an electronic page may advantageously be a document which organizes the presentation of text, graphical images, audio and video.

In addition to the Internet, the communication medium 140 may advantageously include network service providers that offer electronic services such as, by way of example, Internet Service Providers (hereinafter referred to as ISP). An ISP or other network service provider may advantageously support both dial-up and direct connection in providing access to various types of networks. An ISP can be a computer system which provides access to the Internet. Generally, the ISP is operated by an ISP company. Examples of ISP companies include America On-line®, the Microsoft Network®, Network Intensive®, and the like. Typically for a fee, these ISP companies provide a user a software package, username, password, and access phone number. Using this information, the user can then employ the user computers 102, 103 to connect to the ISP and access the Internet. Those of ordinary skill in the art will realize that the ISP is optional and a computer can advantageously execute software programs providing direct access to the Internet. In this instance, the computer may be connected directly to the Internet.

In one embodiment, user computer 101 comprises the entire system for performing the document comparison. User computer 101 comprises a display unit 110, a user interface 112, and a storage device 114. The storage device 114 stores a first document 115, a second document 116 and a document comparison module 117.

As used herein, the word module refers to logic embodied in hardware or firmware, or to a collection of software instructions, possibly having entry and exit points, written in a programming language, such as, for example, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware.

In this single-computer embodiment, the user selects the documents desired for comparison using the user interface 112 to select documents listed on the display unit 110. The selected documents 115, 116 are stored locally on a storage device 114 of the user computer 101. The document comparison module 117, also stored locally on the storage device 114, implements the processes necessary for carrying out the document comparison. The result of the document comparison is output to the display unit 110.

In another embodiment, the user computer 102 comprises a display unit 120, a user interface 112, a storage device 124 and a network interface 127. The storage device 124 stores the selected documents 125, 126 used for comparison. The user computer 102 can communicate the data related to the contents of the document or documents via the network interface 127 over the network 140 to the server computer 150.

The server computer 150 receives the document data via an I/O interface 160. The central processing unit 155 controls the flow of the data over the data bus 195 to the various components of the server computer 150. In some embodiments, the document data is stored in the memory 165 for temporary storage. In other embodiments, the document data is stored in a memory device of the remote document comparison module 170 itself. In further embodiments, the data is stored in the storage device 180.

In one embodiment, the document data is stored as a document in a document database 185. After the server computer 150 receives the document data, the remote document comparison module 170 accesses the document data in order to perform the document comparison.

In yet another embodiment, the user computer 103 comprises a user interface 132, a display unit 130, and a network interface 134. The user connects to the server computer 150 over the network 140 and selects a document or documents from the document database 185 for comparison. Then, the remote document comparison module 170 accesses the document data and performs the document comparison.

In some embodiments, the document database 185 comprises a static portion and a dynamic portion. The static portion consists of versions of the inputted text documents substantially similar to the text documents uploaded to the server computer 150. The dynamic portion consists of versions of the inputted text documents that indicate the identified similar portions and the selected identified similar portions. In other embodiments, the document database 185 comprises only a static portion that stores versions of the text documents substantially similar to the text documents uploaded to the server computer 150. In these embodiments, the system dynamically modifies the display of these documents to indicate the identified similar portions and the selected identified similar portions.

FIG. 1B is a high-level block diagram illustrating one embodiment of the document comparison module. In one preferred embodiment, the document comparison module 200 calls two processes, the document comparison process 210 and the similarity rating process 220. In other embodiments, the document comparison module 200 may call only one of the document comparison process 210 or the similarity rating process 220. It is contemplated that both the document comparison process 210 and the similarity rating process 220 may be each comprised of more than one subprocess. It is further contemplated that the document comparison process 210 and the similarity rating process 220 may be subprocesses of a single process.

### III. External Document Comparison

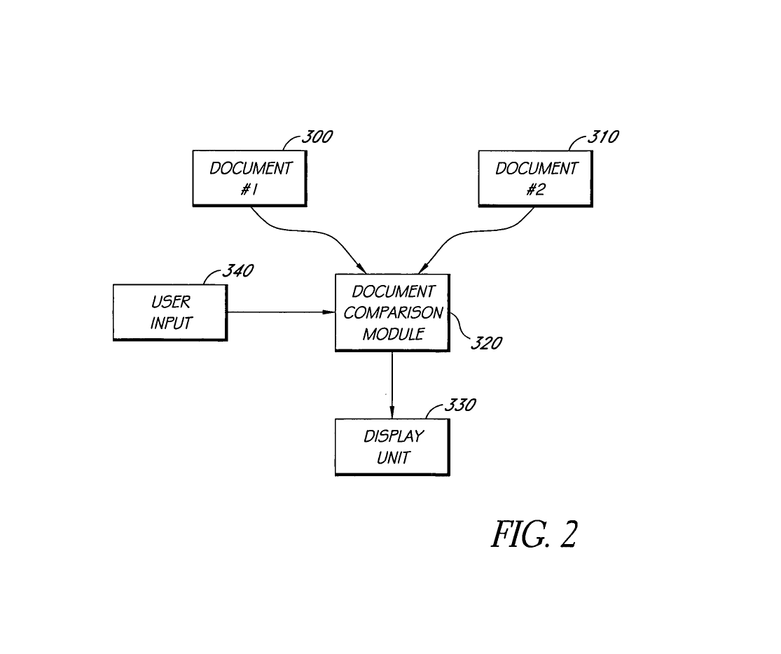

In one embodiment, the document comparison system compares the contents of two documents. FIG. 2 is a high-level block diagram illustrating one embodiment of a document comparison system and method that compares two documents. Document #1 300 and Document #2 serve as inputs to the document comparison module 320. The document comparison module 320 compares the documents in order to identify similar portions of text that are common to both documents. The contents of the documents are output to a display unit 330. Additionally, the display unit 330 visually indicates the identified similar portions of text in each displayed document contents. Moreover, the document comparison module 320 can accept a user's selection 340 of an identified similar text portion. Thereafter, the document comparison module 320 can further indicate the selected similar text portion in the display 330.

As used herein, “similar text portion” refers to alphanumeric text that is common to compared documents. Similar text portions may include, but are not limited to, an identical sentence, a phrase of a specified number of words, a phrase bounded by a semicolon, a phrase bounded by a comma, a phrase or sentence wherein a specified proportion of words are identical, a phrase or sentence that is identical notwithstanding typographical errors, and so forth. In some embodiments, the user may specify the parameters for defining a “similar portion,” and in other embodiments, the system automatically defines a “similar portion.”

The display unit 330 displays the contents of the first document 300 in a first window and the contents of the second document 310 in a second window. Each window can be displayed with a scroll bar that permits the user to independently navigate the contents of each document in order to view a desired portion of the document. In some embodiments, the identified similar portions are selectable links that the user may select by clicking on the text. In other embodiments, the user may select a portion by clicking and dragging a cursor over the portion of text, typing some or all of the portion of text, or using the keyboard to navigate to the portion of text. In response to the user's selection, the system can further indicate the selected similar portion in each of the displayed documents. The system may further indicate the selected similar portions by using a unique text color, by italicizing, bolding and/or underlining the selected text, or by otherwise altering the visual appearance of the text.

In some embodiments, selecting text in one window automatically updates the display in the other window such that the displayed contents of the document include the selected portion. For example, if the user selects sentence A in the first document, the system will automatically display the portion of the second document that contains sentence A, for example, by scrolling the window displaying the second document until sentence A appears in the window.

In another embodiment, the display unit 330 may also contain a third window that displays a list of the identified similar portions of text. In some embodiments, the identified similar portions are displayed as user selectable links. When the user selects a similar text portion, the system further visually indicates the selected similar portion in the list and in each of the displayed document contents. In other embodiments, when the user selects the similar text portion in the list, the system automatically updates the displayed contents of each document such that the portion of each document containing the similar text portion is displayed. For example, when the user selects sentence A from the list, the system automatically displays the portion of the first document that includes sentence A and the portion of the second document that includes sentence A, e.g., by scrolling the respective windows as discussed above.

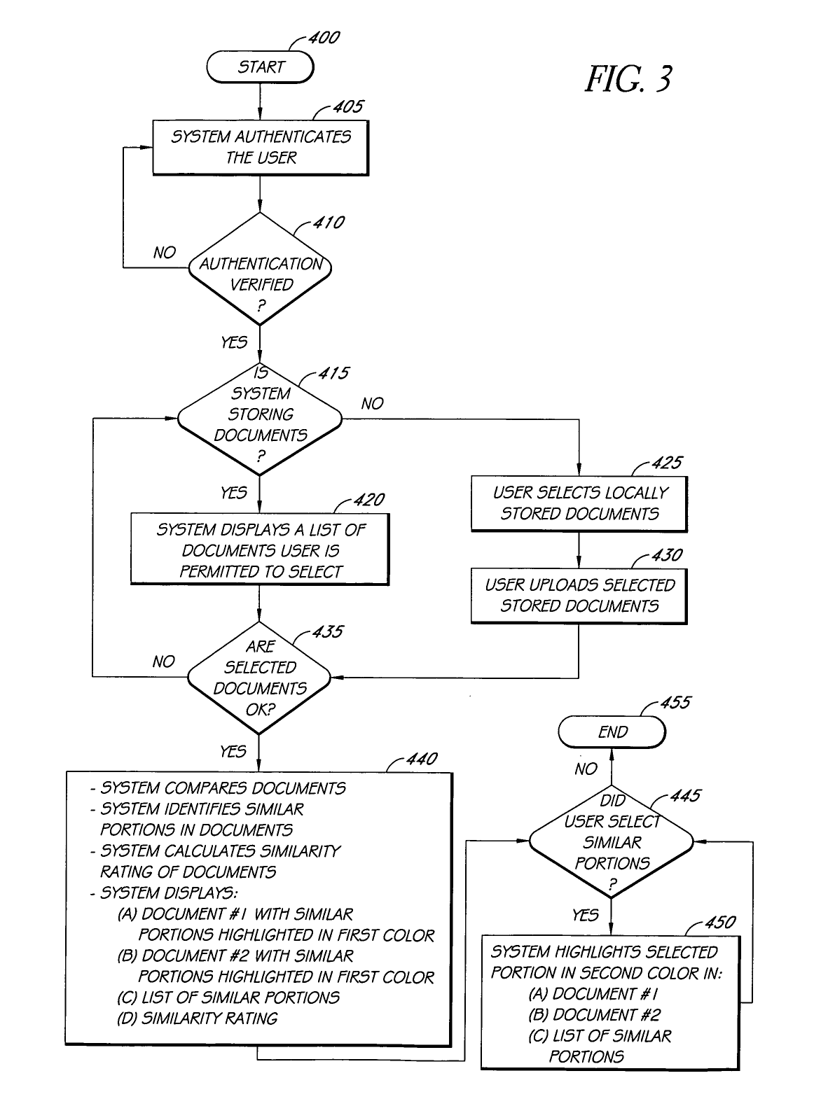

FIG. 3 is a flow-chart illustrating one embodiment of a document comparison process. The process starts 400, preferably by requesting authentication information from the user 405. Authentication information may include a user identification and a corresponding password. If authentication by password is required, the process checks to determine whether the supplied password matches the entered user identification. If authentication is not verified 410, the process repeats the request for user authentication 405. If authentication is verified 410, the process can then query the user as to whether the documents needed for comparison are stored remotely by the server computer 415. If the user indicates that the documents are stored locally on the user computer 425, the user is prompted to upload the stored documents 430 to the server computer. However, if the user indicates that the documents are stored on the server computer 415, the user is permitted to select documents for comparison from a displayed list of documents 420. Alternatively, the process may only accept documents uploaded by the user, circumventing the need for steps 415 and 420.

After the user has selected documents for comparison, the process can preferably check the documents to determine if they are acceptable for comparison 435. Factors involved in determining whether the documents are acceptable for comparison may include, but are not limited to, verifying whether the documents contain alphanumeric text and whether the documents are of a specified file format (for example, Microsoft® Word® format). If the documents are not acceptable for comparison, the process returns to step 415 and again prompts the user to reselect documents. Alternatively, if the selected document is an image file of text pages, the process may ask the user whether they would like to convert the image file into a text document. Such conversion techniques are well known in the art and include, for example, Optical Character Recognition (“OCR”) techniques.

If the selected documents are acceptable for comparison, the process compares the documents 440. The step of document comparison 440 includes, identifying similar portions in the documents and displaying the contents of the documents with the identified similar portions on the display unit 330. In some embodiments, the process identifies similar portions in the documents by executing the following subroutines: (1) creating a first set of all portions in the first document; (2) creating a second set of all portions in the second document; (3) cross-referencing the first set against the second set; and (4) generating a third set of identified similar portions that are common to the first set and the second set. It is contemplated that preceding steps (1) and (2) may be executed in parallel or serially. In other embodiments, the process identifies similar portions in the documents by executing the following subroutines: (1) determining which of the selected documents contains the fewest number of portions; (2) creating a first set of all portions in the shorter document; (3) searching the longer document for each of the portions listed in the first set; and (4) generating a second set of identified similar portions that are common to both documents.

The identified similar portions can then be displayed using a first color or some other first visual indication. In some embodiments, as described above, the process also displays a list of the identified similar portions in a third window. In yet another embodiment, as described below, the process calculates and displays a similarity rating between the documents.

After the process has identified similar portions of text 440, the process determines whether the user has selected one of the identified similar portions 445. If the user indicates that it will not select a similar portion, the process ends 455. However, if the user selects an identified similar portion, the process further indicates the selected similar portion in the first and second documents using a second color or some other second visual indication.

In the embodiments that contain a list of the identified similar portions in a third window, the user may also select the identified similar portion from the displayed list. In this embodiment, the selected portion is further indicated in the displayed list as well as the displayed document contents.

If the user makes a subsequent selection of an identified similar portion 445, the process (a) returns the initially selected identified similar portion to the first color, and (b) further indicates the subsequently selected similar portion, e.g., by changing the selected similar portion to the second color. The process repeats step 450 so long as the user continues to select identified similar portions. However, if the user indicates that he or she will not select additional identified similar portions 445, the process ends 455.

In yet another embodiment, the external document comparison system and method described herein compares the contents of more than two documents. In some embodiments, the system compares the selected documents in order to identify similar portions common to all of the selected documents. For example, if the user selects three documents for comparison, the system will identify sentences A and B in each of the documents if sentences A and B are common to all three documents. The display 330 unit may then either display the contents of all documents simultaneously or display only those documents specified by the user. Further, selection of an identified similar portion is substantially similar to the selection described above with respect to the two document comparison embodiments. Additionally, this embodiment may also include an additional display window that displays a list of the identified similar portions.

In a further embodiment, the system compares multiple documents on a paired basis. That is, the system considers each possible pair of selected documents and identifies similar portions for each pair of documents. For example, if the user selects documents A, B, and C for comparison, the system will make the following individual document comparisons: (a) documents A and B, (b) documents A and C, and (c) documents B and C. After the system makes the comparison, the user selects a compared document pair to view. The display unit 330 then displays the identified similar portions in the contents of document pair. The user may then select one of the identified similar portions in a manner similar to the two document comparison embodiments described above.

### IV. Similarity Rating

In addition to executing the document comparison process 210, the document comparison module 200 may be further configured to execute a similarity rating process 220. The similarity rating process determines the degree of similarity between compared documents and outputs a representation of the degree of similarity to the display unit 330. The degree of similarity between compared documents may be determined by considering some or all of the following factors: (a) the number of words comprising the identified similar portions; (b) the number of words in the shortest of the compared documents; (c) the number of words in the longest of the compared documents; (d) the average number of words in the compared documents; (e) the number of identified similar portions; (f) the number of text portions that are not identified as similar portions; (g) the number of times an identified similar portion appears more than once in one or more of the compared documents; and so forth.

Based on one or more of these factors, the system calculates a representation of the degree of similarity between the two documents. In some embodiments, the representation may be displayed as a quantitative value such as a ratio, percentage or raw number. In other embodiments, the representation may be displayed as a qualitative value such as a color on a color spectrum (for example, a bright shade of red represents a high degree of similarity whereas, a bright shade of blue represents a low degree of similarity).

In embodiments wherein the document comparison system considers multiple pairs of selected documents, the document comparison system can determine a similarity rating for each possible pair of selected documents. The system can also display a list of each possible document pair ordered according to the similarity ratings of each pair. This embodiment may be particularly advantageous in an academic setting. For example, if a professor assigns to his or her students a paper on the same topic, the professor can select all of his students' papers for comparison. The system then generates similarity ratings for each possible pair of documents. By displaying an ordered list of the similarity ratings and the corresponding document pairs, the system advantageously enables the professor to determine if students have engaged in impermissible collaboration or plagiarism.

### V. Internal Document Comparison

In another embodiment, the system performs an internal comparison of a selected text document. In this embodiment, the user selects only one document as an input into the document comparison module 200. After receiving the selection, the system identifies similar portions of the document. For the internal document comparison embodiments, similar portions are portions of text in the document that are repeated at least one time. In some embodiments, the process identifies similar portions in the documents by executing the following subroutines: (1) creating a first set of all portions in the selected document; (2) comparing each portion included in the first set against the remainder of the first set; and (3) generating a second set of identified similar portions that are repeated at least once in the selected document. In other embodiments, the process identifies similar portions in the documents by executing the following subroutines: (1) creating a first set of all portions in the selected document; (2) searching the selected document for each entry in the set to determine if a portion is repeated at least once in the selected document; and (3) generating a second set of identified similar portions that are repeated at least once in the selected document.

As described above with respect to the external document comparison embodiments, the identified similar portions may be sentences, parts of sentences, phrases and so forth. In some embodiments, the system displays the contents of the document, identifying similar portions in a first color. In another embodiment, the system is configured to display a list of the identified similar portions along with the display of the document contents.

Accordingly, the user may then select one identified similar portion in the document. As with the external document comparison embodiments, the user can select the identified similar portions by clicking on the identified similar portion in either the displayed document contents or in the displayed list of identified similar portions. After the selection has been made, the system can further indicate the selected identified similar portion. In some embodiments, selection in either the displayed contents or a list of identified similar portions automatically updates the display (e.g., by scrolling) to show one or more of the following: the previous instance of the selected identified portion, the next instance of the selected identified portion, the first instance of the selected identified portion, every instance of the selected identified portion, or the selected identified portion in the list of identified portions.

In other embodiments, the system identifies each similar portion using a unique color. By using unique colors to denote each set of similar text portions, the system circumvents the need to further indicate a selected identified similar portion.

In yet other embodiments, the system is capable of stepping through each instance of the selected similar portion. For example, suppose the internal document comparison identifies sentence A as a similar portion. After choosing sentence A as the selected identified similar portion, the user can then click on a right arrow or a left arrow represented on the display to automatically scroll to the next or previous instance, respectively, of sentence A in the document.

### VI. Display Example

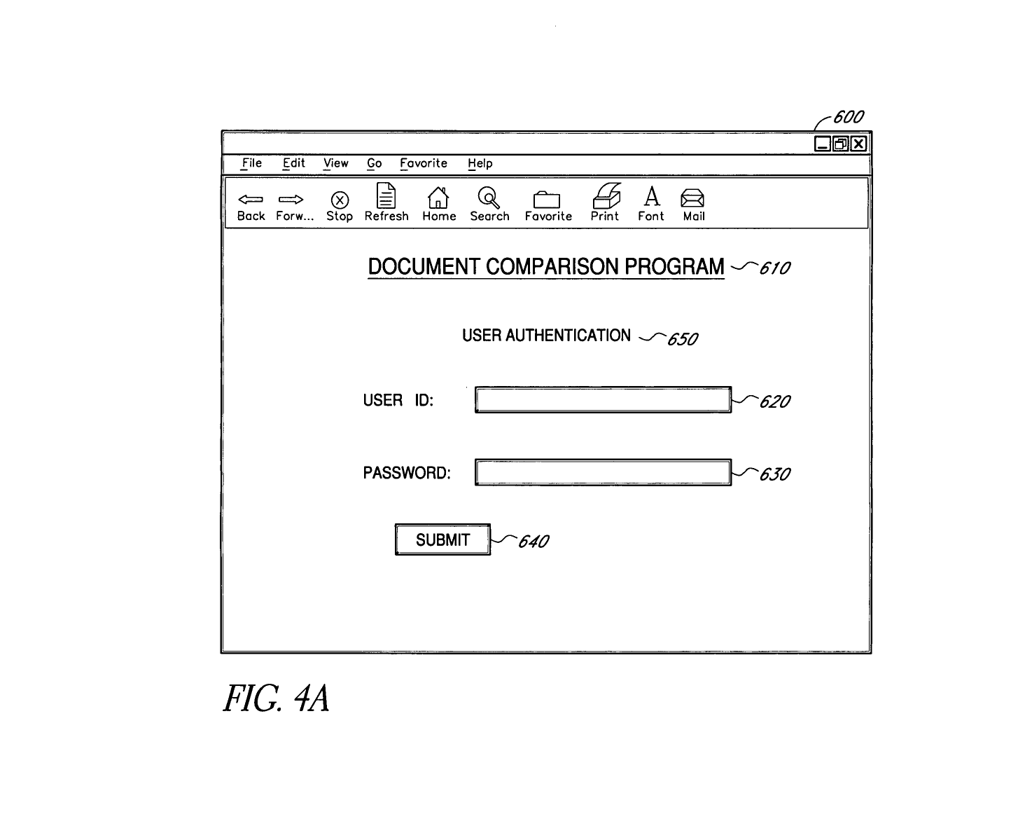

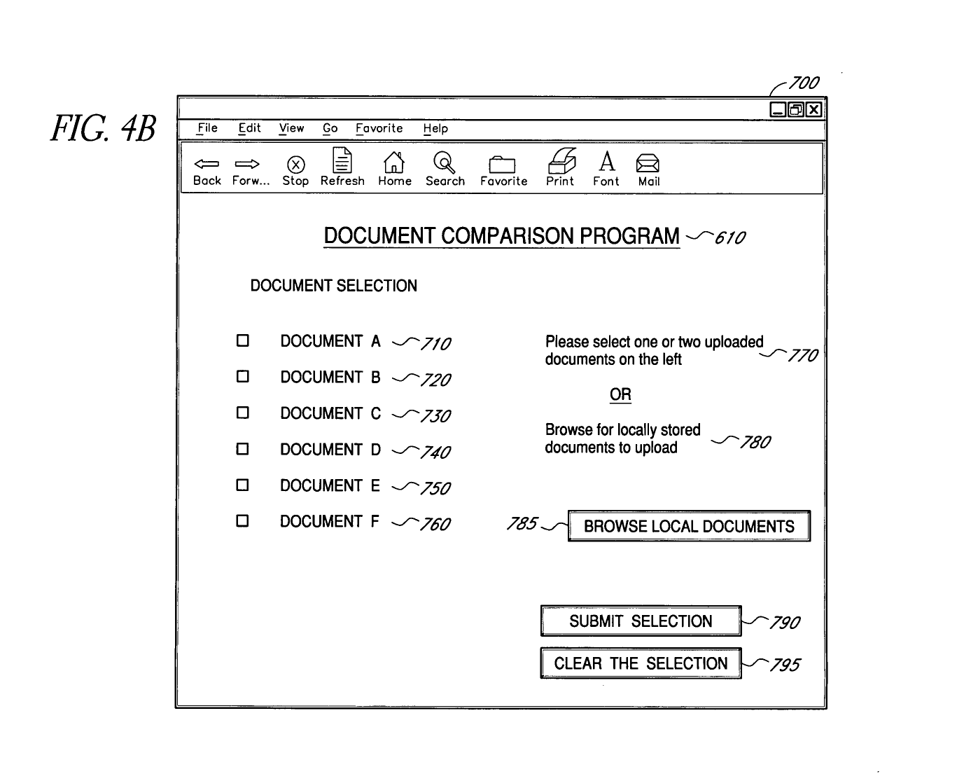

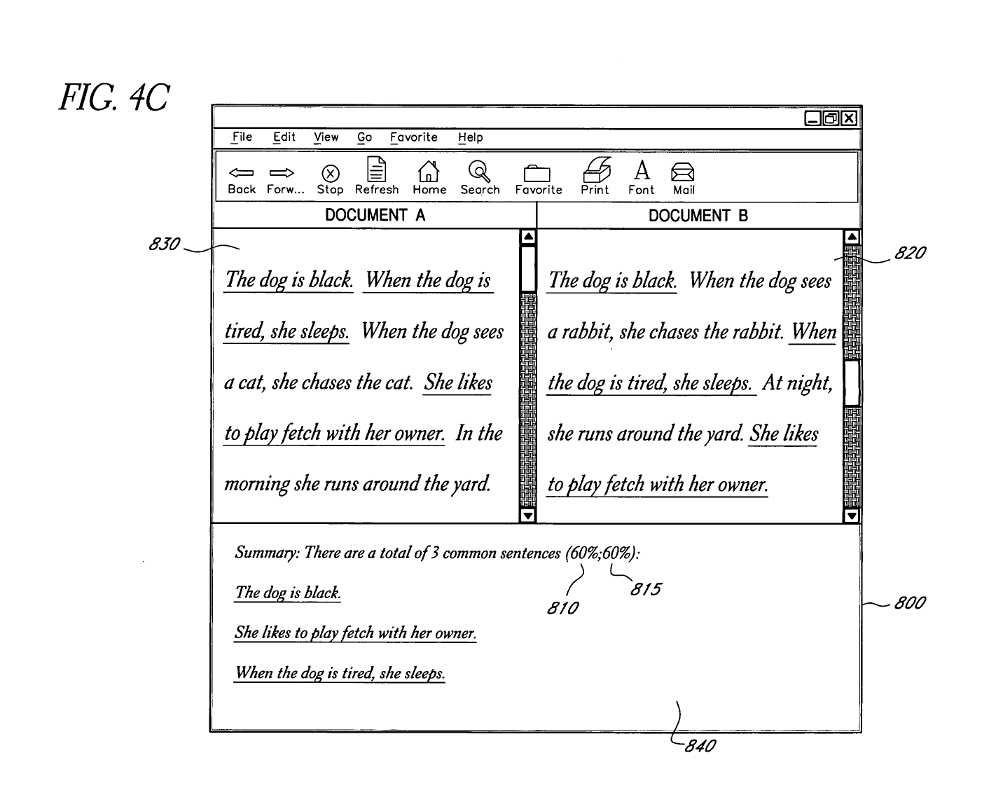

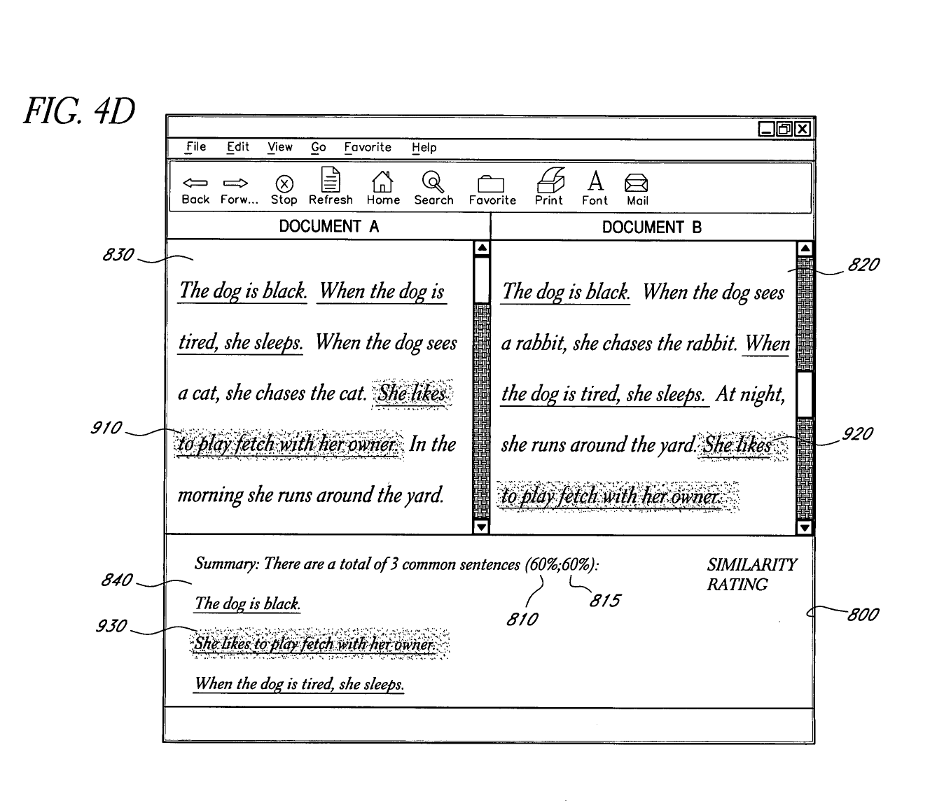

In one embodiment, the user accesses the document comparison system via an HTML page located on the World Wide Web. FIG. 4A is a representation of one embodiment of an HTML page displaying user authentication fields. When the user accesses the document comparison HTML page, the user is presented with a login screen 600. The login screen includes the title of the software 610 (for example, “DOCUMENT COMPARISON PROGRAM”), the title of the HTML page 650 (for example, “USER AUTHENTICATION”), a user ID field 620, a password field 630, and a submit button 640. The user enters his or her user ID in the user ID field 620 and a password that corresponds to the user ID in the password field 630. After entering the required text, the user selects the submit button. The system then verifies whether the user ID and password match a valid user ID and password 410 stored on the server computer 150. If the server computer 150 determines that the user ID and password are valid, the user is granted access to the document comparison system 415.

FIG. 4B is a representation of one embodiment of an HTML page displaying a user's document selection options. The document selection HTML page 700 preferably appears after the system authenticates the user's user ID and password. The document selection web page includes the title of the software 610 and a list of documents 710, 720, 730, 740, 750, 760 remotely located on the server computer 150. Accordingly, the HTML page includes instructions for the user to select documents for comparison 770. The user is alternatively instructed to upload documents for comparison 780 if they are not remotely stored on the server computer 165. In the depicted embodiment, the user may select one or two uploaded documents on the left. If the user selects only one uploaded document, then the system performs an internal document comparison; if, however, the user selects two uploaded documents, then the system performs an external document comparison.

Additionally, if the user chooses to select only documents remotely located on the server computer 165, the user must select the documents using the check boxes located to the left of remotely stored documents A-F 710, 720, 730, 740, 750, 760. However, if the user wishes to upload documents to the server computer, the user must first select the BROWSE LOCAL DOCUMENTS button 785. Selection of this button 785, displays a new window that permits the user to browse the user computer's 102 storage device 124 for locally stored documents 125, 126. When the user uploads locally stored documents, the system updates the document selection HTML page 700. The updated HTML page reflects the recently uploaded document in the list of available documents 710, 720, 730, 740, 750, 760. After uploading documents, the user chooses documents for comparison and selects the SUBMIT SELECTION button 790 when selection is complete. Alternatively, the user may select the CLEAR THE SELECTION button 795 to remove all check marks from the list of selected documents 710, 720, 730, 740, 750, 760.

FIG. 4C is a representation of one embodiment of an HTML page displaying two documents side-by-side and a list of identified similar text portions in the documents. After the user selects the SUBMIT SELECTION button 790 on the document selection HTML page 700, the system compares the selected documents. In the illustrated embodiment, the user selected two documents for comparison. After the system completes the comparison, the user is directed to the side-by-side display HTML page 800. As shown, this HTML page 800 displays three windows: (1) the contents of Document A 830, (2) the contents of Document B 820, and (3) a list of identified similar portions 840. Also shown on the HTML page are similarity rating 810 for Document A and the similarity rating 815 for Document B.

In FIG. 4C, Document A 830 contains the following text: “The dog is black. When the dog is tired, she sleeps. When the dog sees a cat, she chases the cat. She likes to play fetch with her owner. In the morning she runs around the yard.” Document B 820 contains the following text: “The dog is black. When the dog sees a rabbit, she chases the rabbit. When the dog is tired, she sleeps. At night, she runs around the yard. She likes to play fetch with her owner.” Accordingly, the document comparison system identifies similar portions in the document. In the embodiment shown in FIG. 4C, the similar portions are complete identical sentences. The following three similar portions are identified in the document display windows 820, 830 using underlined text: (1) “The dog is black.”; (2) “When the dog is tired she sleeps.”; and (3) “She likes to play fetch with her owner.” Moreover, the HTML page displays the following summary of the similar portions: “Summary: There are a total of 3 common sentences (60%; 60%).” Accordingly, the three identified similar portions also appear in the list of identified, similar portions 840. The displayed similarity ratings 810, 815 are both 60%. The similarity rating 810 for Document A was calculated by dividing the number of common sentences by the total number of sentences in Document A; the similarity rating for Document B was calculated by dividing the number of common sentences by the total number of sentences in Document B. Thus, similarity rating 810 is 60% because 3 of 5 sentences in Document A are common sentences, and similarity rating 815 is 60% because 3 of 5 sentences in Document B are common sentences.

In the depicted embodiment, every instance of an identified similar portion, whether it be in the display area for Document A 830, the document display area for Document B 820, or the list of identified similar portions 840, is a selectable link. FIG. 4D is a representation of one embodiment of an HTML page displaying two documents side-by-side and a list of identified similar text portions in the documents after a user has selected one identified similar text portion. The system further indicates the selected text portion. In FIG. 4D, the user selected “She likes to play fetch with her owner.” by clicking on the identified similar portion in the display area of Document A 830. Accordingly, the system further indicated this identified similar portion using shaded text in the display area for document A 910, the document display area for Document B 920, and the list of identified similar portions 930. By further indicating the selected identified similar portion, a user is able to readily recognize each displayed instance of the selected similar portion.

If, for example, the user selected another identified similar portion, the system would first remove the shading from the originally shaded text 910, 920, 930. Next, the system would further indicate the most recently selected identified similar portion.

### VII. Conclusion

The embodiments described herein may permit a user to advantageously search documents for similar portions of text quickly and accurately. This feature is particularly helpful when examining large or voluminous text documents. A further feature permits a user to consistently alter multiple instances of an identified similar portion by revising only one instance of the similar portion. The convenience added by the systems and methods disclosed herein facilitates rapid and consistent revisions throughout one or more documents. Additionally, systems and methods disclosed herein can be a useful tool for identifying plagiarism in an academic or professional setting.

What is claimed is:

1. A document comparison system, comprising:
a computer; and
software accessible to and executable by said computer such that said computer is operable to:
(a) compare a first document and a second document;
(b) based on said comparison, identify one or more similar portions of said first and second documents;
(c) provide a display containing simultaneously at least some of the contents of said first and second documents;
(d) indicate in said displayed contents of said first and second documents at least one of said identified similar portions;
(e) receive a selection of one of said indicated similar portions; and
(f) in response to said selection, further indicate said selected similar portion in said displayed contents of said first and second documents.

2. The system of claim 1, wherein:
said display contains simultaneously (i) a first display area which displays said contents of said first document, and (ii) a second display area which displays said contents of said second document; and
said software is executable by said computer such that said computer is operable to receive said selection of one of said indicated similar portions in one of said first and second display areas; and, in response to said selection, further indicate said selected similar portion in the other of said first and second display areas.

3. The system of claim 1, wherein said similar portions are identical portions of said documents.

4. The system of claim 1, wherein:
said first and second documents comprise alphanumeric text; and
said similar portions comprise an identical alphanumeric text passage.

5. The system of claim 4, wherein said identical alphanumeric text passage comprises at least one identical sentence.

6. The system of claim 1, wherein said selection is made by a user depressing a surface on a computer input device.

7. The system of claim 1, wherein said indicated similar portions are selectable links configured to indicate said similar portions in said first and second display areas.

8. The system of claim 1, wherein said software is executable by said computer such that said computer is operable to access a data storage device which stores said first document and said second document.

9. The system of claim 1, wherein said display contains simultaneously (i) a first display area which displays said contents of said first document, (ii) a second display area which displays said contents of said second document; and (iii) a third display area which displays a list of said indicated similar portions.

10. The system of claim 1, wherein said software is executable by said computer such that said computer is operable to produce a representation of the degree of similarity between said first and second documents.

11. A document comparison system, comprising:
a computer; and
software accessible to and executable by said computer such that said computer is operable to:
(a) compare a first document and a second document;
(b) based on said comparison, identify one or more similar portions of said documents; and
(c) provide a display containing simultaneously (i) at least some of the contents of said first document, (ii) at least some of the contents of said second document, and (iii) a list of said identified similar portions.

12. The system of claim 11, wherein:
said display contains simultaneously (i) a first display area which displays said at least some of the contents of said first document, (ii) a second display area which displays said at least some of the contents of said second document, and (iii) a third display area which displays said list of said identified similar portions; and
said software is executable by said computer such that said computer is operable to receive a selection of one of said identified similar portions in one of said first, second and third display areas; and, in response to said selection, further indicate said selected similar portion in the other two of said first, second and third display areas.

13. The system of claim 11, wherein:
said first and second documents comprise alphanumeric text; and
said identified similar portions comprise an identical alphanumeric text passage.

14. The system of claim 13, wherein said identical alphanumeric text passage comprises at least one identical sentence.

15. The system of claim 11, wherein said list comprises user-selectable links which correspond to said identified similar portions.

16. The system of claim 15, wherein said first and second documents comprise user-selectable links which correspond to said identified similar portions.

17. The system of claim 15, wherein said software is executable by said computer such that said computer is operable to indicate said identified similar portions upon selection of said user-selectable links.

18. The system of claim 11, wherein said software is executable by said computer such that said computer is operable to access a storage device which stores said first and second documents.

19. The system of claim 11, wherein said software is executable by said computer such that said computer is operable to produce a representation of the degree of similarity between said first and second documents.

20. A method for comparing documents, said method comprising:
comparing a first document and a second document;
based on said comparison, identifying one or more similar portions of said first and second documents;
displaying simultaneously at least some of the contents of said first and second documents;
indicating in said displayed contents of said first and second documents at least one of said identified similar portions;
receiving a selection of one of said indicated similar portions; and
in response to said selection, farther indicating said selected similar portion in said displayed contents of said first and second documents.

21. The method of claim 20, said method further comprising:
displaying simultaneously (i) said contents of said first document in a first display area, and (ii) said contents of said second document in a second display area; and
receiving said selection of one of said indicated similar portions in one of said first and second display areas; and, in response to said selection, further indicating said selected similar portion in the other of said first and second display areas.

22. The method of claim 20, wherein said similar portions are identical portions of said documents.

23. The method of claim 20, wherein:
said first and second documents comprise alphanumeric text; and
said similar portions comprise an identical alphanumeric text passage.

24. The method of claim 23, wherein said identical alphanumeric text passage comprises at least one identical sentence.

25. The method of claim 20, wherein said selection is made by a user depressing a surface on a computer input device.

26. The method of claim 20, wherein said indicated similar portions are selectable links configured to indicate said similar portions in said first and second display areas.

27. The method of claim 20, said method further comprising accessing a data storage device which stores said first and second documents.

28. The method of claim 20, wherein said display contains simultaneously (i) a first display area which displays said contents of said first document, (ii) a second display area which displays said contents of said second document; and (iii) a third display area which displays a list of said indicated similar portions.

29. The method of claim 20, said method further comprising producing a representation of the degree of similarity between said first and second documents.

30. A method for comparing documents, said method comprising:
comparing a first document and a second document;
based on said comparison, identifying one or more similar portions of said first and second documents; and
displaying simultaneously (i) at least some of the contents of said first document, (ii) at least some of the contents of said second document, and (iii) a list of said identified similar portions.

31. The method of claim 30, said method further comprising:
displaying simultaneously (i) said at least some of the contents of said first document in a first display area, (ii) said at least some of the contents of said second document in a second display area, and (iii) said list of said identified similar portions in a third display area; and
receiving a selection of one of said identified similar portions in one of said first, second and third display areas; and, in response to said selection, further indicating said selected similar portion in the other two of said first, second and third display areas.

32. The method of claim 30, wherein:
said first and second documents comprise alphanumeric text; and
said identified similar portions comprise an identical alphanumeric text passage.

33. The method of claim 31, wherein said identical alphanumeric text passage comprises an at least one identical sentence.

34. The method of claim 30, wherein said list comprises user-selectable links which correspond to said identified similar portions.

35. The method of claim 34, wherein said first and second documents comprise user-selectable links which correspond to said identified similar portions.

36. The method of claim 34, said method further comprising indicating said identified similar portions upon selection of said user-selectable links.

37. The method of claim 30, said method further comprising accessing a data storage device which stores said first and second documents.

38. The method of claim 30, said method further comprising producing a representation of the degree of similarity between said first and second documents.

39. A document comparison system, comprising:
a computer; and
software accessible to and executable by said computer such that said computer is operable to:
(a) receive a document;
(b) identify a first portion of said document and a second portion of said document, said second portion being similar to said first portion;
(c) provide a display containing at least some of the contents of said document;
(d) indicate said first and second portions in said displayed contents;
(e) receive a selection of said first portion; and
(f) in response to said selection, further indicate said second portion.

40. The system of claim 39, wherein said software is executable by said computer such that said computer is operable to display a list of a plurality of said similar portions.

41. The system of claim 40, wherein:
said display contains simultaneously (i) a first display area which displays said contents of said document, and (ii) a second display area which displays said list; and
said software is executable by said computer such that said computer is operable to receive said selection of said first portion in one of said first and second display areas; and, in response to said selection, further indicate said second portion in the other of said first and second display areas.

42. A method for comparing a document, said method comprising:
receiving a document;
identifying a first portion of said document and a second portion of said document, said first portion being similar to said second portion;
providing a display containing at least some of the contents of said document;
indicating said first and second portions in said displayed contents;
receiving a selection of said first portion; and
in response to said selection, further indicating said second portion.

43. The method of claim 42, the method further comprising displaying a list of a plurality of said similar portions.

44. The method of claim 43, wherein:
said display contains simultaneously (i) a first display area which displays said contents of said document, and (ii) a second display area which displays said list; and
said selection of said first portion is received in one of said first and second display areas; and, in response to said selection, further indicating said second portion in the other of said first and second display areas.
